(19) United States
(12) Patent Application Publication
(10) Pub. No.: US 2005/0108557 A1
(43) Pub. Date: May 19, 2005

(54) Systems and methods for detecting and preventing unauthorized access to networked devices

(76) Inventors: David George Kayo, Corona, CA (US); Andrew Atilla Pal, Las Vegas, NV (US); Michael Tubbs, Mission Viejo, CA (US)

Correspondence Address: Donald Bollella;DB TECHNICAL CONSULTING, 126 Almador, Irvine, CA, 92614, US

(21) Appl. No.: 10/962,159

(22) Filed: Oct. 8, 2004

Related U.S. Application Data
(60) Provisional application No. 60/510,786, filed on Oct. 11, 2003.

(51) Int. Cl. H04L 9/32

(52) U.S. Cl. 713/189

(57) ABSTRACT

Devices, systems, and methods for detecting and preventing unauthorized access to computer networks. Devices include a server enabled with an application that interacts with a counter-part PC application to determine whether input devices of the PC have been active within a predetermined time. Methods include providing a subscription-based service for PC users to determine whether unauthorized network output activity has occurred from a respective user's PC.

### CROSS-REFERENCE TO RELATED APPLICATIONS

The present application claims the benefit of priority from U.S. Provisional Application Ser. No. 60/510,786 filed Oct. 11, 2003 which is incorporated herein by reference in its entirety.

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all rights whatsoever relating to the copyright material contained herein.

### BACKGROUND OF THE INVENTION

1. Field of the Invention

This invention, in general, relates to computer networks and, in particular, to security devices, systems, and methods directed to ensure proper use of such networks. More specifically, but without restriction to the particular embodiments hereinafter described in accordance with the best mode of practice, this invention relates to devices, systems, and methods for detecting and preventing unauthorized access to computer networks.

2. General Discussion and Related Art

A computer connected to a public or private network operates with inherent risks. There are risks of intrusions from external sources and internal sources. Additionally, further risks include the presence of network savvy software applications which render the owner of the computer in violation of use standards such as copyright law and other emerging Internet related laws. This may occur with or without the computer owner's knowledge.

Currently, there are several known applications for detecting computer viruses that are directed to computers by improper use of the network to which such computers may be connected. One inherent limitation of these “anti-virus” applications is their ineffectiveness against new viruses. Typical anti-virus software currently cannot act in real-time, near-real-time, or instantaneously against new and unknown viruses. Thus several weeks may pass before such applications are up-dated to guard against new viruses. In addition, such typical anti-virus software is incapable of detecting so-called “zombie attacks”.

Recent news stories have reported the devastating effects that may be caused by such computer or network “hackers”. Many businesses, universities, hospitals, stock exchanges, and government agencies rely on private or public computer networks, such as the Internet, to transact and conduct a wide variety of activates. Intentional misuse of such networks may thus bring substantial harm to private economic interests with possible compounding effects on national economies.

Thus in the current world of inter-related and inter-connected computer networks, there is a need to provide improved devices, systems, and methods for detecting and preventing unauthorized access and use of such computer networks.

### OBJECTS AND SUMMARY OF THE INVENTION

It is, therefore, an object of the present invention to improve upon limitations in the prior art. These and other objects are attained in accordance with the present invention wherein there is provided several embodiments of a network and computer protection system and various methods relating thereto.

It is a principal aspect of the present invention to provide a system for detecting and preventing unauthorized access to user devices. The system disclosed herein includes a server having a central control device and a plurality of user devices capable of communicating with the central controller device through a network. The system disclosed herein further includes an application residing in the user devices. The central control device is configurable to probe the user devices for potential intrusions in unison with the assistance of the application residing in the user devices and transmit corrective actions to user devices prior to the occurrence of such intrusions. This enables preemptively preventing unauthorized access to the user devices. The user devices can include personal computers, digital assistants, and/or hand held devices. The network described herein includes wired or wireless networks including a network employing TCP/IP.

An aspect of the present invention is to provide a system for detecting and preventing unauthorized access to user devices, wherein the application residing in the user device is configurable to generate a threat definition data on the occurrence of an incidence of intrusion, review the threat definition data to determine whether it is a new threat, and if it is, transmit the threat definition data to the central control device. Typically, the incidence of intrusions include viruses, Trojan horses, worms, unknown security vulnerabilities, software vulnerabilities, rogue applications, zombie attacks, pc hijacking, and peer-to-peer file sharing.

In another aspect, the present invention discloses a system for detecting and preventing unauthorized access to user devices, wherein the system includes an application residing in the user device and the user device further includes a buffer configurable to store the threat definition data generated by the application residing in the user device.

According to still another aspect hereof, the present invention discloses a central control device which is capable of verifying and validating the threat definition data received from the application residing in the user device. If the threat definition is found valid, the central control device propagates a set of execution codes, command sets, and/or instructions to one or more user devices having the application.

In yet another aspect, the system for detecting and preventing unauthorized access to user devices disclosed herein is configurable to halt communications within the user device for purposes of disallowing transmission of copy protected information such as movies or music, whether or not it is deliberately initiated on user device.

It is also an aspect of the present invention to configure a system for detecting and preventing unauthorized access to user devices having a central control device to send commands to a user device through the network for identifying the presence of a particular application and/or service that is capable of transmitting commands to the device to in turn disallow the application or service from performing further transmissions.

In accordance with yet another aspect hereof, the present invention includes a system for detecting and preventing unauthorized access to user devices implemented for the purpose of detecting and disabling peer to peer software presence, internet relay chat software presence, instant messaging software presence, and/or FTP (file transport protocol) software presence.

Still yet another aspect of the present invention is directed to a central control device in a system for detecting and preventing unauthorized access to user devices. The central control device is capable of detecting and/or monitoring repetitious, suspicious and/or malicious behavior for the purpose of alerting another network to preemptively halt, disallow and/or allow the suspicious, repetitious and/or malicious behavior on that network prior to its presence.

Another aspect of the invention disclosed herein is a central control device in a system for detecting and preventing unauthorized access to user devices capable of remotely storing and/or saving information regarding network activity of a specific and/or non-specific nature as determined for a component and/or sub-component operating on the secure and/or non-secure target network.

It is another principal aspect of the present invention to provide a method for detecting and preventing unauthorized access to user devices. This method includes the steps of generating a threat definition data on the incidence of an intrusion by an application residing in a user device, temporarily storing the threat definition data in a buffer, reviewing the threat definition data to ascertain if it is a new threat, submitting the threat definition data to the central control device, verifying and validating the threat definition data by the central control device, and propagating corrective actions to user devices prior to the occurrence of similar intrusions thus preemptively preventing unauthorized access to the user devices.

In another aspect of the methods hereof, the present invention is directed to a method for detecting and preventing unauthorized access to user devices wherein the incidence of intrusion include viruses, Trojan horses, worms, unknown security vulnerabilities, software vulnerabilities, rogue applications, zombie attacks, pc hijacking, and peer-to-peer file sharing.

In still another aspect, the present invention includes a method wherein the corrective actions being propagated by the central control devices to the user devices having the application include set of execution codes, command sets, and/or instructions.

In yet another aspect the methods disclosed herein may include the steps of detecting by internally viewing operational applications and/or service by name and/or function and/or connection and/or associated data to identifying the presence of programs and/or applications which violate intellectual property laws such as but not limited to patents, copyrights, and trademarks.

It is another aspect of the present invention to provide a method for monitoring activity from input devices such as a keyboard and/or mouse employed by the user devices for the purpose of determining whether network activity is initiated by non human means.

It is also an aspect of the present invention to provide a method for checking the last time a person used the keyboard or mouse on a computer at the time of a credit card purchase in order to verify that the credit card owner is using the credit card in question, such as the case of an internet purchase, the credit card processor would query the server and/or personal computer which would provide the time passed since the person last moved the mouse and/or keyboard to determine whether the transaction is potentially fraudulent.

In another embodiment hereof, the methods disclosed herein provide locally interrupting network requests and not allowing them to occur in the event that the network requests are occurring at an interval determined by a threshold.

This invention relates in general to a centrally managed protection device and system. Coordinated systems of protected network devices such as computers which are potentially decentralized operate in unison with the assistance of a central control. The central control externally probes systems for vulnerabilities and transmits corrective actions to the protected systems to preemptively thwart intrusion possibilities. From an external location, the central control is able to probe for the presence of applications which render the owner of the computer in violation of use standards such as copyright law, file sharing applications, and other emerging Internet related laws.

Upon the computer, an associated application resides which probes the system for applications which may create legal or other use violations. This application also provides assistance to third parties by preventing requests to specified servers, to reduce the effect of denial of service network attacks. This feature may be remotely triggered by the central control. The application is also able to preemptively determine a previously unknown network attack, and transmit the information regarding the new threat to the other computers via the central control.

The present system enables the computer to operate with enhanced safety. The system can internally or externally determine whether software is operating which creates an unlawful activity such as sharing, for example, music or movie files which are owned by others. The system can determine the presence of a network based attack, and notify one or more other computers of the attack for the purpose of preemptively thwarting the attack on the other computers prior to its occurrence. The system also provides logic for the purpose of learning the nature of a network attack, and provides this information to other computers for the purpose of preemptively thwarting the attack prior to its occurrence. The system can be instructed to preempt an activity, such as in the case of a decentralized “zombie” attack. In the case of such an attack, a multitude of computers with no inherent association simultaneously bombard a single server on the internet. Within the system, such an attack may be lessened or nullified by the distribution of preemptive instruction to block all transmissions to the targeted server for a period of time, or until instructed otherwise. The targeted server owner may request action in the instance that its server is under attack. The plurality of computers would be sent instructions to avoid the targeted server. This action may be requested by voice, phone, fax, or other medium.

A new computer when shipped, may have inherent vulnerabilities. The computer may be owned by a person who is not technically savvy and would require assistance to protect their computer from network attacks such as Internet attacks.

The present system provides a service which operates on the computer. This service monitors network activity searching for patterns which indicate a network attack. Such attacks may be in the form of a port scan for example. If an external computer made requests to various channels (such as ports in a TCP/IP connection) the service would block the requests, even though an actual intrusion has not occurred. The service operates in conjunction with a centralized system. The centralized system provides preemptive information to the computer so that intrusions have a higher likelihood of being thwarted. Additionally, the system is able to perform standard network safety tests. The system is able to send requests to various channels (such as TCP/IP ports) for the purpose of determining the presence of illicit or unauthorized activity. Such an activity could be peer-to-peer file sharing, internet relay chat (IRC), or instant messaging. The system utilizes the determination of the presence of this activity to instruct the computer to stop the offending application, and/or block the channel (port) in order to cease the activity.

Prior hereto, network protection relied on monitoring network device at the point of potential incident. Additionally, external probing techniques have been employed to test the strength of a network protection device or system. Examples of such devices include “SNORT” which is a public domain external probing application for the purpose of testing a network or computers security. With the advent of network intrusions being modified at faster rates and with more application which present potential risks, the need to preemptively block unknown intrusions is greater than ever.

As a significant advance over prior art and related apparatus or methods, the present invention provides various embodiments such as the ability to provide internal and external identification and halting the functionality of file sharing applications which would put the computer owner at risk of legal violations, such as the file sharing of music and movies.

As another significant advance over prior art and related apparatus or methods, the present invention provides a system where external and internal systems operate in unison to identify and prevent new unknown intrusion methods.

As yet another significant advance over prior art and related apparatus or methods, the present invention provides the ability to disable any attempts to a network device such as a web server. In the event of a denial of service attack, the attacked company may send a message to the central control which would notify all computers to not allow web service requests to the affected server. In this situation, the attacked server is not overloaded further by the computers. Third party servers may use this service to provide a message to the computer user which is more informative than the standard server not responding message.

As still another significant advance over prior art and related apparatus or methods, the present invention allows the historical data relating to network intrusions and intrusion attempts to be provided to a third party such as the computer manufacturer in order to assist the third party in assisting the computer owner with their computer.

As yet still another significant advance over prior art and related apparatus or methods, the present invention enables the creation of a computer enabling all of the features within this invention.

### BRIEF DESCRIPTION OF THE DRAWING

Further objects of the present invention together with additional features contributing thereto and advantages accruing therefrom will be apparent from the following description of preferred embodiments of the invention which are shown in the accompanying drawing figures with like reference numerals indicating like components throughout, wherein:

FIG. 1 is a block diagram of a server with the central control device connected through a network such as the internet to a number of user devices;

FIG. 2 is diagram of a display window providing a variety of preferences available in the application;

FIG. 3 is a block diagram showing a user device having a buffer operating in conjunction with application;

FIG. 4 is an example of a control device connected through a network to a number of user deices and a third party device such as the web server which needs computers to not access it for a period of time;

FIG. 5 is an example of the third party network device not being accessed or requested by the client computers after notification by the control device;

FIG. 6 is a flow chart showing the general principle of operation of the application device in conjunction with the central control device; and

FIG. 7 is a flowchart explaining in detail the functioning of the application having the various activities available for the users.

### DETAILED DESCRIPTION OF THE PREFERRED EMBODIMENTS

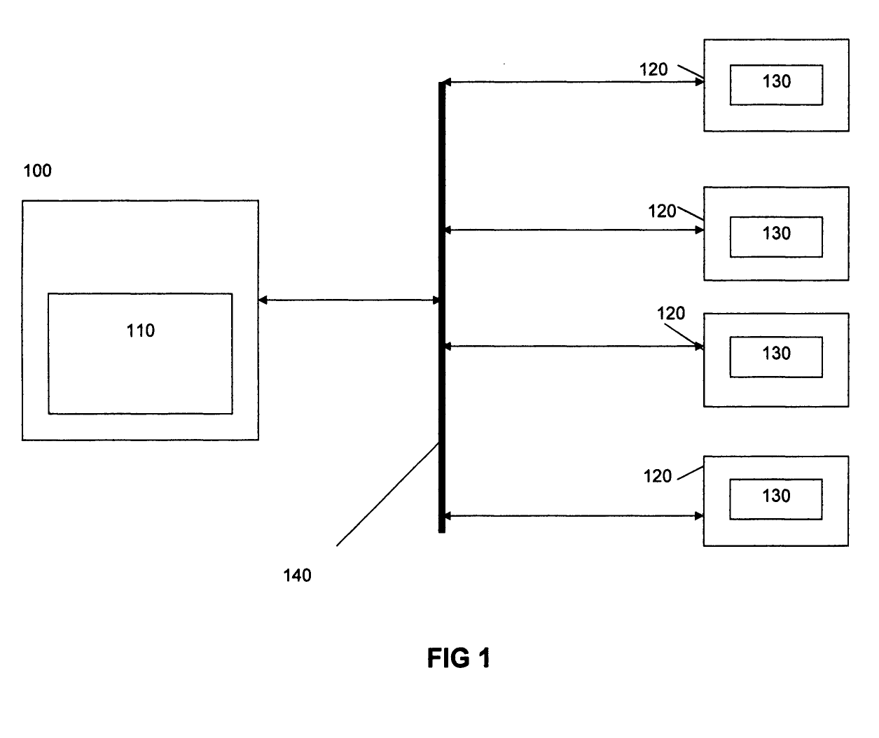

FIG. 1 is a block diagram showing the server 100 having a central control device 110, which is connected through a network 140 such as the internet, to a plurality of user devices 120. An application 130 resides/downloaded on the user devices 120 interacts with the central control device 110 as well as with other user devices 120 on the network.

The application 130 provides for a variety of activities available for the operator user devices 120 where the application 130 resides for detecting and preventing unauthorized access to computer networks.

The application 130 on the user devices 120 can interrogate the user device 120 to identify other applications that are potentially harmful. These harmful applications are not merely restricted to Trojan horses, worms, unknown security vulnerabilities, known vulnerabilities, software vulnerabilities, rogue applications, zombie attacks, pc hijacking, and peer-to-peer file sharing as can be found in prior art such as virus scanning software. The application locates and identifies programs or tasks, which put the computer owner/operator at risk of being liable for illegal activities. These detected applications and tasks may be file-sharing programs, which share and swap music, movies or illegal images. By detecting these processes, the application 130 is able to disable the incoming requests for the illicit material, and disable the outgoing requests to other file sharing computers. The application 130 can then alert the operator of the user device about the activity allowing them to uninstall or delete the programs.

The application 130 is able to arbitrarily identify potential invasions of tasks, which are safety risks. It is able to monitor the network usage of tasks, and identify new tasks, which use network resources. If the network usage of a task is far too high for normal usage, the task is disabled, and the port it is using is disabled. The application is able to identify new unknown threats by examining network packets and finding inconsistencies such as broken packet headers.

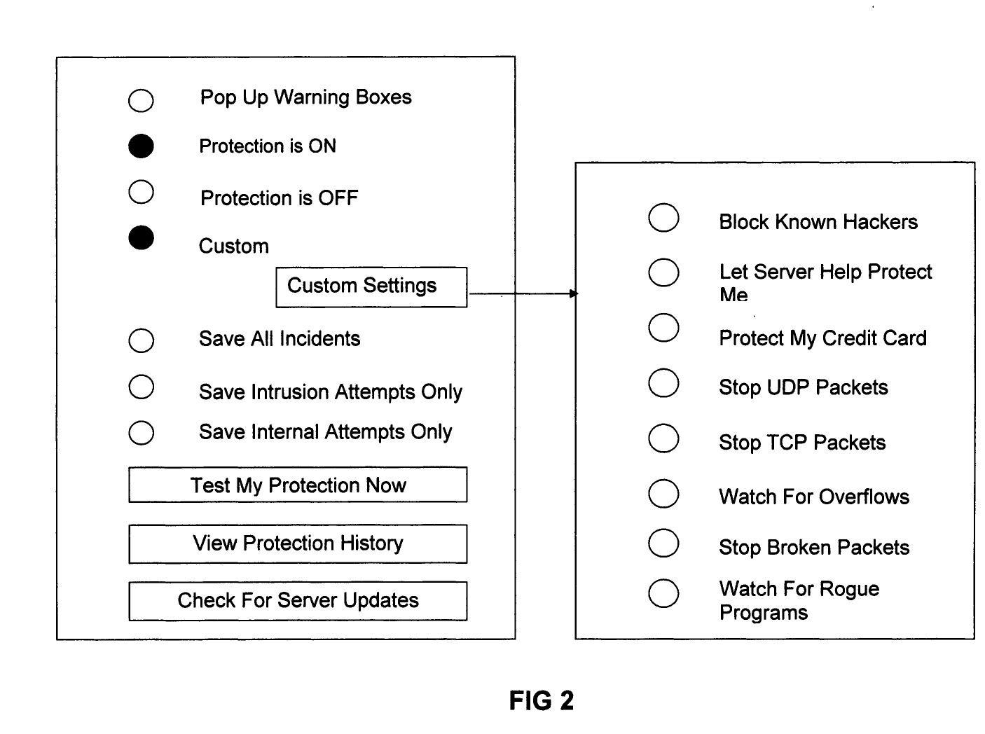

FIG. 2 shows the variety of preferences available in the application 130 to the user. If the Pop Up Warning Boxes is enabled, anytime the user's device 120 learns about a new threat or an unauthorized access, a box will pop up and alert the operator. If the operator does not want to have the box pop up, the operator may disable it by un-checking the option.

The Pop Up boxes are warning or informative boxes that appear on the screen when the application 130 discovers one of the following: 1) External Intrusion attempts, 2) Internal Peer-to-Peer activity, 3) Internal program contacting other computers without you instructing it to, 4) External Peer to Peer activity trying to contact programs on a PC, 5) IRC activity which is not legible text, 6) Messenger messages, which are not text, 7) “Pings”, 8) “Port” scans, 9) Use of a credit card without proper approval, 10) External connections trying to get information, 11) External connections trying to put files on your computer, and 12) Other activities deemed questionable.

If the protection is turned ‘ON’, it will protect the user devices 120 with full mode security.

The custom settings further provides the operator to enable or disable certain features like blocking the known operator, allowing the Server 100 to help protect the individual user devices 120, protect credit card, stop UDP packets, stop TCP packets, watching activity overflow, stop broken pieces, and watching rogue programs.

The History Option available with the application 130 keeps track of what happens with the user device 120. This information can be used for personal information, or may be retained in case anything occurs. This information assists the user and the application 130 in apprehending someone who is trying to gain access to the user's device 120, or to prove that the operator is not responsible for some kind of activity. It can also allow the operator to know all the programs that have been accessed and run.

The activity, Test My Protection Now, is a feature that should be used from time to time such as when any new program is installed and run or when the operator wants to make sure that everything is safe. When this option is chosen, application 130 in the user device 120 will perform an internal test, and it will perform an external test. The internal test will check “outbound” activities while looking for software that may want to send out private information and which should not be present in the user's computer. The external test will perform simulated attacks from the central control device 110 in the server 100. These tests will identify any shortcomings in the user's computer and they will be automatically flagged and protected.

The activity, View Protection History, provides a list of anything that has occurred to the user's computer or to the user's credit card. Things that may be listed here include hacker attacks on the computer; attempts to use file sharing programs to get illegal music, installed programs which have internet virus activities in them and even illegal attempts to use the user's credit card.

The activity, Check For Server Updates, checks if there are any program updates or threat profiles which need to be transmitted to the user device 120.

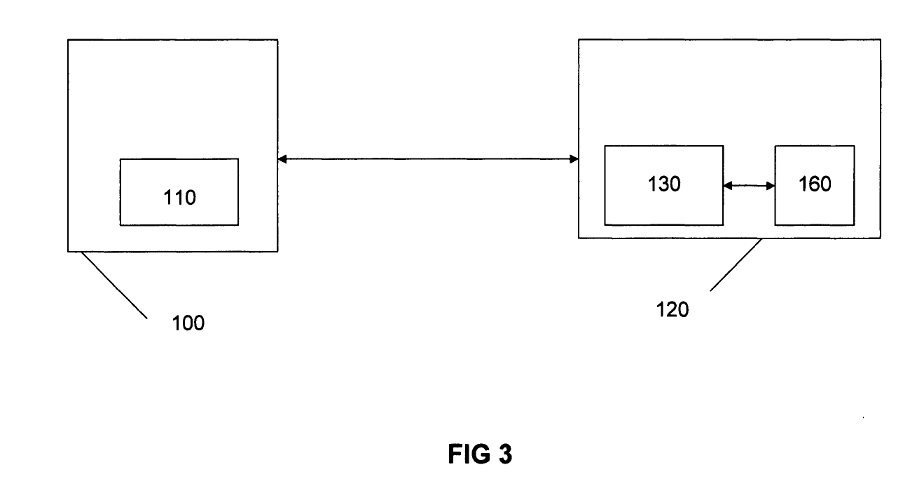

FIG. 3 shows a block diagram showing a buffer 160 residing at the user device 120 and is operating in conjunction with the application 130. The application upon keeping a track of all the activities happening at the user device 120 generates a threat definition data and stores the same temporarily in the buffer. The information that is gathered would include no keyboard & mouse activity, TCP/IP packets, UDP packets, inspection of packets, header packets, packet lengths, structure of packets, port number, location of files, keyboard and mouse activity, network activity, where file was received, received e-mails, time of attack, file format, structure of process, and network activity buffer.

Submission of threat definition data takes place directly after it has been generated. Once generated, it is submitted and noted in the database of where it came from and to inform the consumer of the attack that was just attempted on their personal computer. At this point, the threat definition data would be sent to the central control device 110 for verification and validation. Data goes into the buffer, is reviewed, and then either released, discarded, or reviewed as a new threat.

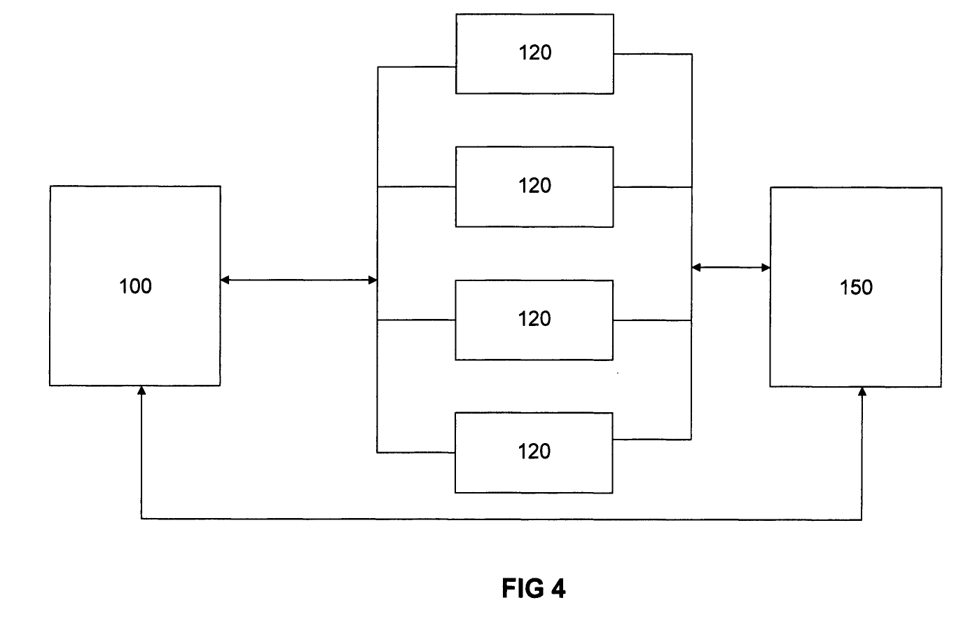

FIG. 4 is a block diagram showing 3rd party network device 150 which is connected with the user devices 120 as well as the central control device 110 of the server 100.

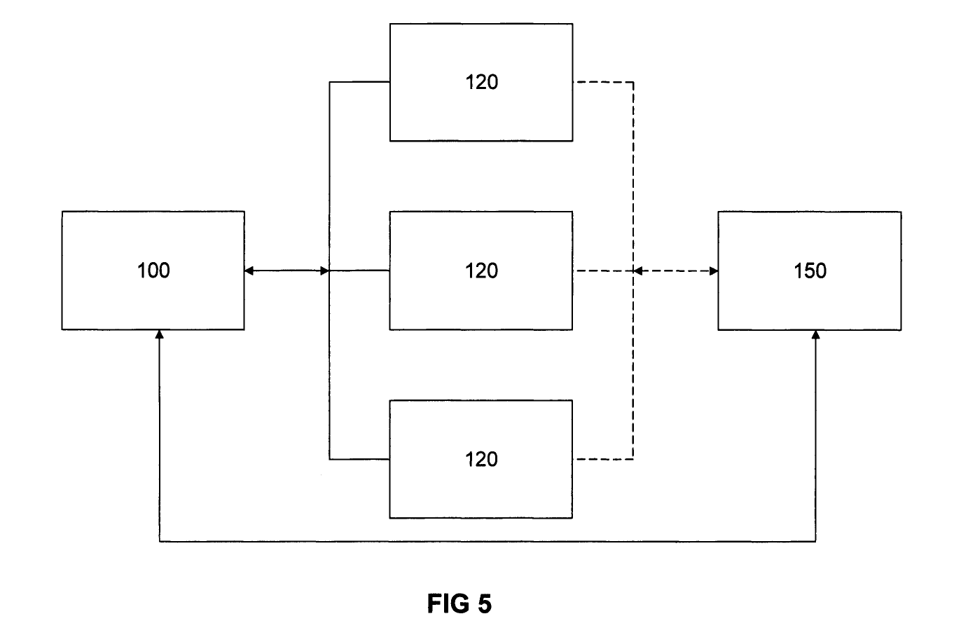

FIG. 5 is a block diagram showing another stage of the system as depicted in FIG. 4. If the 3rd party network device 150 is having an attack, the device 150 can contact the central control device 110 to request that all other user devices 120 not access the affected device 150. Upon receipt of such request the central control device 110 stops the other user devices 120 from accessing the infected network device 150. The respective user devices 120 are provided with a message stating that the device 150 such as a web server is not available at that time.

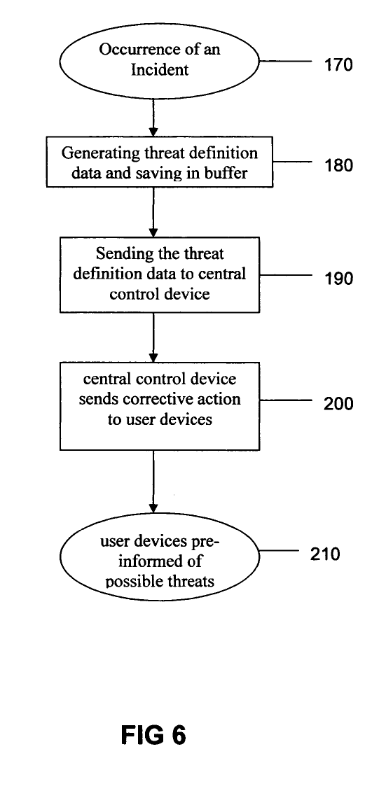

FIG. 6 is a flowchart depicting the general method of operation of the application 130 in conjunction with the central control device 110. The application 130 receives an incident as in step 170. The incident could be any of the following: viruses, Trojan horses, worms, unknown security vulnerabilities, known vulnerabilities, software vulnerabilities, rogue applications, zombie attacks, pc hijacking, and peer-to-peer file sharing. A threat definition data would be generated and the same would be saved in the buffer 160 in step 180. The application 130 then sends the threat definition data to the central control device 110 as mentioned in step 190. The central control device 110 sends the corrective action to the network user devices 120 shown in 200. The user devices 120 in the network are pre-informed of all the possible threats shown in step 210.

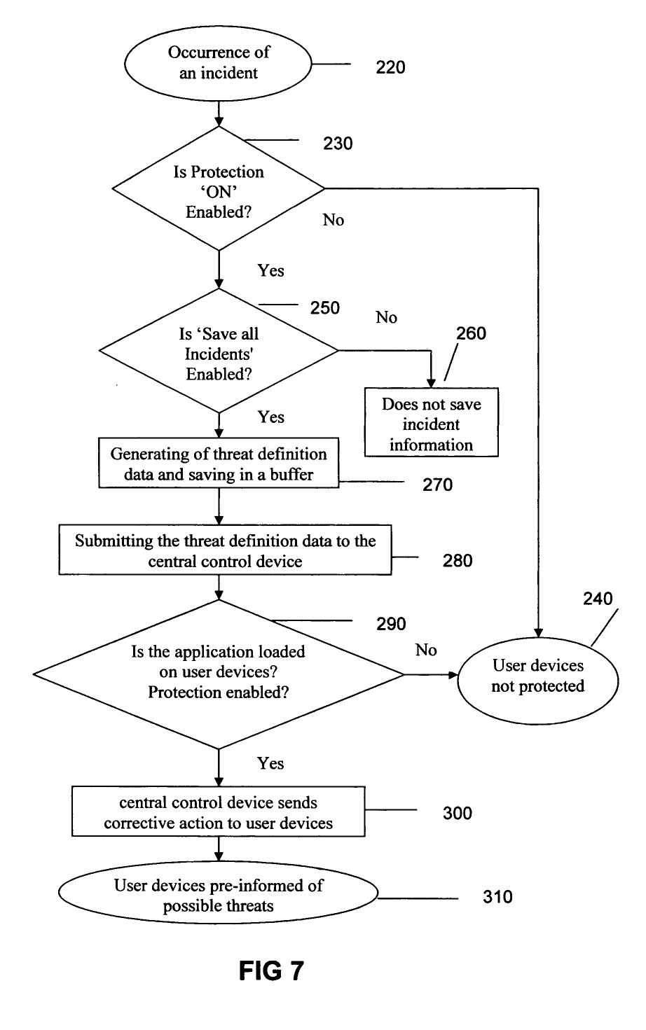

FIG. 7 is flowchart explaining in detail the functioning of the application having the various activities available for the users. The application 130 receives an incident in step 220. The application 130 checks whether the activity Protection ‘ON’ is enabled as shown in step 230. If the activity is not enabled, the device is not protected against any threats on the network, step 240. If the activity is enabled, the application 130 checks for whether the activity ‘Save all Incidents’ is enabled as shown in step 250. If the answer is NO, the application 130 does not save the information on the incidence of an intrusion and thereby the threat definition data is not generated shown in 260. If the answer is YES, generating a threat definition data and saving in a buffer 160 shown in 270. Thereafter, submitting the threat definition data to the central control device 110 shown in 280. The central control device 110 verifies whether the application 130 is loaded on user devices 120 and is also Protection enabled, step 290. If not, the user devices 120 are not protected and the corrective actions are not propagated to user devices. If YES, the central control device 110 sends corrective action to network user devices 120, step 300. And thereby, the user devices 120 are pre-informed of possible threats shown in step 310.

1. A system for detecting and preventing unauthorized access to user devices, said system comprising:
a server having a central control device;
a plurality of user devices in communication with the central control device through a network; and
an application residing in the user devices, the central control device being configurable to probe the user devices for potential intrusions in unison with the assistance of the application residing in the user devices and transmit corrective actions to user devices prior to the occurrence of such intrusions to thereby preemptively prevent unauthorized access to the user devices.

2. The system according to claim 1 wherein the user devices comprise computer systems, portable digital assistants, and hand held communication devices wherein the application is configured.

3. The system according to claim 1 wherein the network comprises wired or wireless networks including a network employing TCP/IP.

4. The system according to claim 1 wherein the application residing in the user device is configurable to generate a threat definition data on the occurrence of an incidence of intrusion, review the threat definition data to determine whether the incidence is a new threat, and if it is, transmit the threat definition data to the central control device.

5. The system according to claim 4 wherein the incidence of intrusions include viruses, Trojan horses, worms, unknown security vulnerabilities, software vulnerabilities, rogue applications, zombie attacks, pc hijacking, and peer-to-peer file sharing.

6. The system according to claim 4 further comprising a buffer associated with the application residing in the user device, the buffer being configurable to store the threat definition data generated by the application residing in the user device.

7. The system according to claim 1 wherein the central control device upon receipt of the threat definition data generated by the application residing in the user device verifies and validates the threat definition data.

8. The system according to claim 6 wherein the central control device upon verifying the threat definition data, and determining the threat definition to be valid, propagates a set of execution codes, command sets, or instructions to at least one user device having the application.

9. The system according to claim 1 configured to halt communications within the user device to thereby disallow transmission of copy protected information.

10. The system according to claim 1 configured to send commands to a user device through the network for identifying the presence of a particular application, service, or application and service that is capable of transmitting commands to the user device to in turn disallow the application, service, or both from performing further transmissions.

11. The system according to claim 9 implemented for the purpose of detecting and disabling peer-to-peer software presence, internet relay chat software presence, instant messaging software presence, or FTP (file transport protocol) software presence.

12. The system according to claim 1 wherein the central control device is capable of detecting or monitoring repetitious, suspicious, or malicious behavior to thereby alert another network to preemptively halt, disallow, or allow the suspicious, repetitious, or malicious behavior on that network prior to its presence.

13. The system according to claim 1 wherein the central control device is capable of remotely storing or saving information regarding network activity of a specific or non-specific nature as determined for a component or sub-component operating on the secure or non-secure target network.

14. The system according to claim 1 configured to receive and process third party communications.

15. A method of detecting and preventing unauthorized access to user devices, said method comprising:
generating a threat definition data on the incidence of an intrusion by an application residing in a user device;
temporarily storing the threat definition data in a buffer;
reviewing the threat definition data to ascertain whether it is a new threat;
submitting the threat definition data to the central control device;
verifying and validating the threat definition data by the central control device; and
propagating corrective actions to user device prior to the occurrence of similar intrusions to thereby preemptively prevent unauthorized access to the user device.

16. The method according to claim 15 wherein the incidence of intrusion include viruses, Trojan horses, worms, unknown security vulnerabilities, software vulnerabilities, rogue applications, zombie attacks, pc hijacking, and peer-to-peer file sharing.

17. The method according to claim 15 wherein the corrective actions being propagated by the central control devices to the user devices having the application include set of execution codes, command sets, or instructions.

18. The method according to claim 15 further comprising detecting by internally viewing operational applications or service by name, function, connection, or associated data to identify the presence of programs or applications which violate intellectual property laws including patents, copyrights, or trademarks.

19. The method according to claim 15 further comprising monitoring activity from an input devices such as a keyboard or mouse employed by the user devices for the purpose of determining whether network activity is initiated by non human means.

20. The method according to claim 15 further comprising checking a last time a person used the keyboard or mouse on a computer at a time of a credit card purchase in order to verify that an owner of the credit card is using the credit card.

21. The method according to claim 15 wherein in the case of an internet purchase, the credit card processor queries the server or personal computer to provide the time passed since the person last moved the mouse, keyboard, or both to thereby determine whether the transaction is potentially fraudulent.

22. The method according to claim 15 further comprising locally interrupting network requests and preventing from occurring when the network requests are occurring at an interval determined by a threshold.
